(19) United States
(12) Patent Application Publication
(10) Pub. No.: US 2019/0212222 A1
(43) Pub. Date: Jul. 11, 2019

(54) GEOSYNTHETIC CLAY LINER WITH ELECTRICALLY CONDUCTIVE PROPERTIES

(71) Applicant: IMAGINE INTELLIGENT MATERIALS LIMITED, Menai, New South Wales (AU)

(72) Inventors: Phillip AITCHISON, Castlecrag (AU); Grant MATHIESON, Athelstone (AU); Vito GIORGIO, Victoria (AU)

(21) Appl. No.: 16/093,134

(22) PCT Filed: Apr. 12, 2017
(86) PCT No.: PCT/AU2017/050322

§ 371 Date: Oct. 11, 2018

(30) Foreign Application Priority Data
Apr. 12, 2016 (AU) 2016901355

(51) Int. Cl. G01M 3/40; D06M 11/74; B32B 5/02; B32B 5/06; D01F 1/09; H01B 1/04; E02D 31/00

(52) U.S. Cl. CPC G01M 3/40; D06M 11/74; B32B 5/022; D06M 2101/40; D01F 1/09; H01B 1/04; E02D 31/004; B32B 5/06

(57) ABSTRACT

An electrically conductive geosynthetic clay liner incorporating an electrically conductive textile graphene.

### TECHNICAL FIELD

The invention relates to the field of geosynthetic materials and their manufacture. In particular, the invention relates to a geosynthetic clay liner including a geotextile that has conductive properties.

### BACKGROUND OF THE INVENTION

Geosynthetic membranes are water barrier layers widely used as barrier layers when building water retention facilities (e.g. dams and ponds) or water guidance facilities (e.g. drainage and canals). These membranes can be deployed on a large scale and may potentially cover many thousands of square meters. These protective layers are often referred to as “geosynthetics” and can be waterproof plastic membranes and/or composites containing clays.

Clay lining is the traditional method of waterproofing water retention facilities. Modern composites of clay and geotextile are known as a “geosynthetic clay liner” or “GCL”. These offer improved performance over traditional clay earthworks and are used in reservoirs and landfills.

A GCL typically comprises at least three layers: i.e. a layer of clay sandwiched between two geosynthetic layers. The two geosynthetic layers used to sandwich the clay can be any combination of woven or non-woven geotextile, geogrids, geonets or geomembranes. For example, the structure may comprise a strengthening or backing layer of geogrid or geonet and a non-woven geotextile. The strengthening layer can be a woven textile or net. The clay is often bentonite and may contain additives, such as polymeric binders and or stabilisers.

The sandwich structure can be given robustness by securing each of the geosynthetic layers to the other, via the clay intermediary, using fibres. In some cases, the fibres come from a non-woven geotextile, wherein the fibres are needle punched, or hydro-entangled, through the clay to the other geosynthetic. It is advantageous to secure the geotextile fibres to the backing layer by bonding them to the backing layer by melting, gluing and other methods known in the art. In other cases, the sandwich can be stitched together. In some cases, glue is used to secure the geosynthetics to the clay. To provide greater robustness in glued GCLs an adhesive can be mixed into the clay. In other cases, only one geosynthetic is used and the clay is held to itself and to the geosynthetic with adhesive. Combinations of these known GCL structures are possible and others can be envisaged.

Water barrier layers, such as pond liners and GCLs, must retain their barrier properties and be able to be tested to ensure they retain their barrier properties. Even a small hole in the liner can result in significant water leakage, especially over time. In some cases, for example in holding mining waste, where the water is contaminated and is being retained or directed to protect the environment, even small amounts of leakage are significant and can cause substantial environmental harm, and may incur large costs to rectify. In such applications, the integrity of the liner is critical, as is the ability to determine that integrity at all times.

In other applications such as where water is being retained for further use, the loss of that water has a cost which merits an investment in ensuring barrier integrity.

In many cases a layer of GCL is used on a base of prepared earthwork and then a layer of plastic waterproof geomembrane is laid either directly on the GCL or in some cases with spacing and/or protective layers between the two. In some cases, the geomembrane is part of the GCL.

Inspection of the integrity of the (usually electrically insulating) waterproof geomembrane barrier can include electrical inspection, where a voltage is applied to the surface of the insulating barrier and, under the right conditions, a circuit can be formed through any defects in the barrier material. For a circuit to be formed, an electrical conduction mechanism on the opposite side of the barrier to which the voltage is applied is required. Where an electrolyte, even a very weak one, is present under the barrier, sufficient current can be carried to form a circuit through the defect and to the inspection equipment. For example, clay is often a sufficient electrolyte due to its salt and water content. FIG. 1 illustrates this type of circuit.

To assist with the formation of a conductive pathway, water can be used as part of the structure, to facilitate the inspection process. In cases where the clay is dry it does not function as an electrolyte, so the conductive inspection mechanism becomes unreliable. In cases where multiple layers of insulator are present in the barrier layer, no reliable mechanism for forming a circuit exists.

To overcome this problem of reliability several approaches have previously been proposed in the field to introduce reliable electrical conductivity into the assembly. One involves incorporating metal wires. This has been tried by: incorporating the wires into a textile; by sandwiching them between two layers of a textile; and by laying them onto a textile. The textile is then incorporated into the construction of the barrier layer, usually beneath the waterproof geomembrane. Another approach has been to make the waterproof geomembrane liner as a bi-layer with the surface (water facing side) being electrically insulating and the opposing side being electrically conducting, for example by the lamination of two layers of plastic, the opposing side layer containing carbon black to provide electrical conduction. Similarly, three or more layers can be used in the barrier layer.

However, all of these approaches present problems in one or all of the following: the manufacture of the various layers; the installation of the various layers; or the inspection of the assembly.

Accordingly, it is an object of the invention to provide a geosynthetic clay liner that ameliorates at least some of the problems associated with the prior art.

### SUMMARY OF THE INVENTION

According to a first aspect of the invention, there is provided a geosynthetic clay liner incorporating an electrically conductive textile. Said textile may incorporate conductive fibres or be coated with a conductive coating. The conductive fibres preferably contain graphene, ore are coated with graphene, or alternatively the textile itself may be coated with graphene. In some embodiments, the conductive fibres contain or are coated with other conductive substances, such as metals or other allotropes of carbon. The electrically conductive textile thereby provides electrical conductivity to said geosynthetic clay liner.

Graphene is an individual layer of graphite that can be formed by many techniques, including “top-down” approaches such as mechanical or electrochemical exfoliation of graphite, chemical oxidation of graphite and exfoliation as graphene oxide followed by partial or complete reduction to graphene; and “bottom-up” approaches such as growth from gases or plasmas on substrates or catalysts. The character of the graphene can vary from nearly atomically perfect single layers through two-layer, few-layer and multi-layer graphene all the way up a scale of number of layers which culminates in large agglomerates similar to ultra-fine graphite. Graphene has a high aspect ratio, being ultimately only one atomic layer thick (less than one nanometre) and typically hundreds of nanometres to hundreds of microns in the planar directions. Thus, graphene is often referred to as being a two-dimensional (2D) material. Graphene is an excellent electrical conductor.

The inventors have found that graphene can be incorporated into and onto fibres and textiles to form an electrically conducting textile that provides a reliable mechanism for inspection of barrier liners in water retention applications, providing substantial advantages over other proposed methods for inspection of barrier liners.

Preferably, said textile forms an electrical circuit whose conductivity may be measured over a distance of at least 1 metre, advantageously up to 100 metres or more.

Preferably, the graphene content of the textile is less than or equal to 20% by mass, or advantageously less than or equal to 10% by mass, or advantageously less than or equal to 5% by mass.

Preferably, the fibres of the textile are polymer fibres, for example polyethylene terephthalate (PET), polypropylene (PP) or polyethylene (PE).

According to another aspect of the invention, there is provided a multi-layer construction incorporating the electrically conducting geotextile as described above. The multi-layer construction incorporates a clay, which acts as a water barrier layer and a backing textile or net. The three layers are preferably formed into a single multi-layer sandwich by entangling the geotextile through the clay and securing to the backing textile or net. If required, more than three layers can be incorporated.

Such multi-layer constructions may advantageously facilitate an in-situ inspection process to determine whether the water barrier is intact.

According to another aspect of the invention, there is provided a method of inspecting the integrity of a water barrier, wherein said water barrier incorporates a multi-layer construction as described above, said method including the steps of: applying a voltage to one side of the insulating water barrier proximal to said electrically conductive GCL; and detecting whether an electrical circuit is thereby formed in the GCL.

Electrical resistance can be reported in many ways. For electrical conduction in a thin sheet, the unit “Ohms per square” (“Ohm/sq” or “Ohm/□”) is often used and referred to as “sheet resistance”. This unit is of practical advantage in that it reflects a desired outcome regardless of how the material being measured is constructed. For example, two sheets of electrical conductor may have different specific resistances but may nevertheless give the same, desirable sheet resistance if present in different thicknesses. Sheet resistance is normally applied to uniform thickness films, but can also be applied to non-uniform sheets of conductors, such as the textiles described herein.

There are many methods of measuring electrical resistance, including simple multimeter readings. Where high resistances are present, such as in the case of some embodiments of conductive geotextiles, a high voltage measurement is useful, such as those given by electrical insulation resistance meters (commonly called ‘megaohm meters’, or by the brand name “Megger” or “Meggar”). Industry often uses high voltage “Holiday” detectors to detect defects in insulating layers. A simple high voltage, low current source such as a Tesla coil can also be used to detect electrical conductivity at very low levels. More accurate measurements are given by four-point resistance meters.

Preferably, the electrical resistance of said textile is less than 2500 Ohms per square, advantageously as low as 50 Ohms per square, or lower.

Preferably, the measurement method employs the use of a discontinuous electrical circuit, via an intrinsic capacitance, wherein the resistance of the textile is less than 500,000 Ohms per square, advantageously as low as 50,000 Ohms per square, or lower.

Now will be described, by way of a specific, non-limiting examples, preferred embodiments of the invention with reference to the drawings.

### BRIEF DESCRIPTION OF THE DRAWINGS

FIG. 1 is a schematic of an inspection circuit used to detect defects in a waterproof geomembrane that acts as a barrier layer, according to the state of the art.

FIG. 2 is a schematic of an alternative inspection circuit used to detect defects in a waterproof geomembrane that acts as a barrier layer, according to the state of the art.

FIG. 3 is a schematic of the use of an electrically conductive GCL in an inspection circuit used to detect defects in a waterproof geomembrane, according to the invention.

FIG. 4 is a schematic of an electrically conductive GCL suitable for use in an inspection circuit used to detect defects in a waterproof geomembrane, according to the invention.

### DETAILED DESCRIPTION OF THE INVENTION

The invention resides in the use of graphene as an electrically conducting component of a polymer fibre for a geotextile that is incorporated in a multi-layer geosynthetic clay liner, for use as one part of a water barrier for man-made earthworks where another part of the water barrier is an electrically insulating plastic geomembrane. The invention enables a way to test the geomembrane for defects, such as holes, via the electrical properties imbued by the graphene.

Turning to the figures, we note that FIG. 1 is a schematic illustration of a traditional inspection circuit used to detect for defects in a barrier layer (11) using a voltage/current source (14). When the inspection probe (13) is close to a defect (16), such as a hole, current will flow through the defect (16) into the earthwork base (12) via the earth contact (15) to form a continuous circuit. This circuit can only be formed when the earthwork base (12) is electrically conductive, which is often not the case, and is thus unreliable.

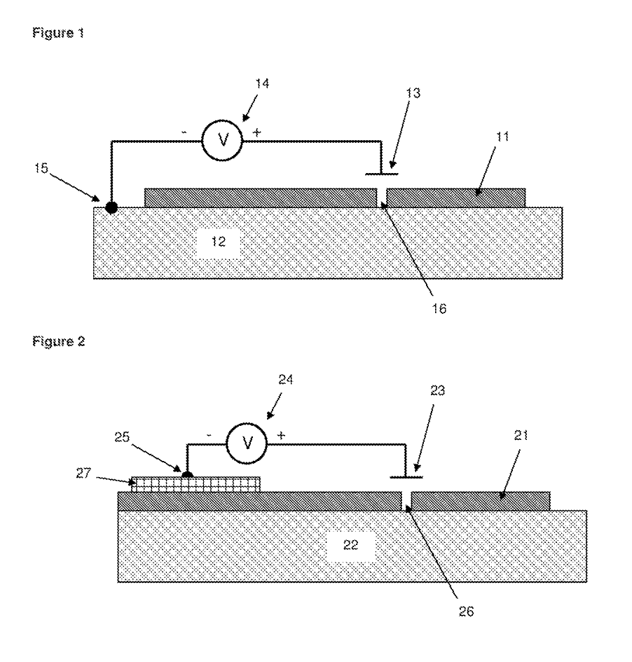

FIG. 2 is a schematic illustration of an alternative configuration of the inspection system of FIG. 1. Instead of direct contact by the earth (25) to the earthwork base (22), a relatively large area earth pad (27) is used to provide indirect electrical contact via a capacitance, where the barrier layer (21) provides a dielectric between the earth pad (27) and the earthwork base (22).

FIG. 1 illustrates an example of the circuit formed when electrical leak detection is performed on a simple water barrier assembly with a conductive under-layer such as a water-containing clay base. Clay is used in many cases to prepare the ground for water retention (e.g. dams and ponds) and water direction (e.g. canals and drainage). Clay also provides a good medium for electrical conduction due to its water and ionic content. If the clay base is partially or completely dry this process is not reliable and may not work at all. Also, if there is poor physical contact between the barrier layer and the clay base, caused by for example, air or water pockets, the inspection process can be unreliable. In the absence of a clay base, or equivalent, the inspection process is unreliable.

Traditional earthworks utilising clay bases as water barriers require substantial thicknesses of clay, sometimes measuring in the hundreds of centimetres of thickness. These traditional earthworks can be replaced by geosynthetic clay liners with as little as one centimetre of clay thickness.

Electrical inspection techniques are typically either low voltage or high voltage. Low voltage techniques typically require an electrically conductive layer on both sides of the membrane. This is provided by water being present in the area being inspected (often referred to as “water lance” or “water puddle” techniques). High voltage techniques (often referred to as “arc” or “spark” techniques) do not require a conductor on the side of the barrier layer being inspected (typically the “top” layer) and can use many thousands of volts to ensure that small holes, even pinholes, can be detected.

Two principal mechanisms of forming an earth connection are illustrated in FIG. 1 and FIG. 2. In FIG. 1 an earth (25) is formed where the electrical conductor is connected to the conducting under-layer (not shown in FIG. 1), e.g. by inserting a metal rod into the clay base, or by attaching to the conductive textile under-layer. In FIG. 2 an area of conductor, the earth pad (27) rests on top of the nominally insulating barrier layer (21). In some instances, the barrier layer (21) is not a perfect insulator so over a large contact area such as that formed by the earth pad (27) enough current can flow to through the circuit between the probe (23) and the earth (25). In other instances, the barrier layer (21) acts as a dielectric and the earth pad (27) acts as one electrode of a capacitor.

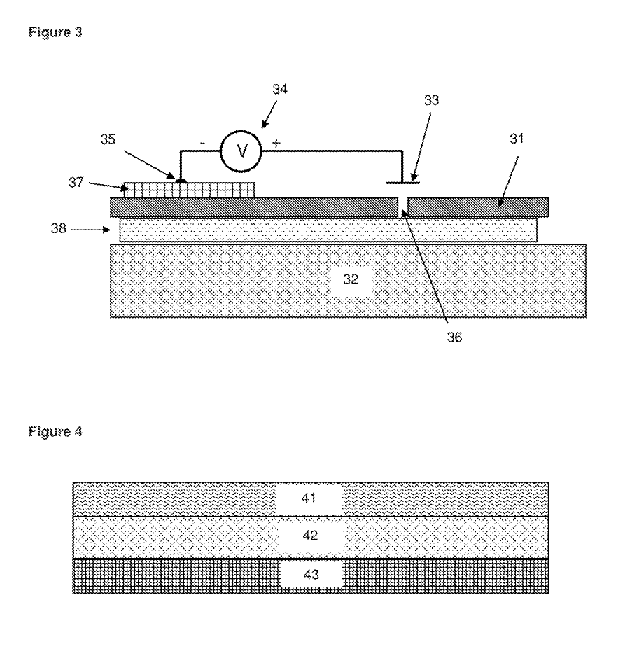

FIG. 3 is a schematic illustration embodying the application of the invention. An inspection circuit is used to detect for defects in a barrier layer (31) using a voltage/current source (34). When the inspection probe (33) is close to a defect (36), current flows through the defect (36) into and through the electrically conductive GCL (38) via the earth contact (35, 37) to form a circuit.

FIG. 4 is a schematic illustration of the three layers used to construct a geosynthetic clay liner. The Electrically Conductive Geotextile (41) and the backing layer (43) of textile or net, sandwich the clay barrier layer (42).

If, as illustrated according to the invention in FIG. 3, a conducting layer is added underneath the barrier Layer (31) as part of the GCL (38), the earthwork base (32) may be any material and no other conductivity beneath or in the barrier layer (31) is required. The incorporation of graphene into or onto the geotextile used in the GCL will tend to make the GCL sufficiently electrically conductive to allow both low and high voltage inspection techniques to be performed depending on the thickness of the barrier layer (31) and the size of the defect (36) that needs to be detected. The larger the defect (36) and the thinner the barrier layer (31) the lower the voltage required for inspection. FIG. 3 illustrates this configuration with the electrically conductive GCL (38) and the inspection configuration.

Electrical inspection for defects in the barrier layer can be performed by many methods. Industrial standards have been set to normalise the inspection conditions. These are embodied in the following international standards documents: ASTM D6747, ASTM D7002, ASTM D7007, ASTM D7240, ASTM D7703 and ASTM D7852.

Electrical inspection methods rely on electrical conductivity to form a circuit. Sufficient conductivity depends on the size and length of the conductive path and the conductivity of the media (water, earth, conductive textile, barrier layer). This combination of variables gives a wide range over which the inspection methods can be effective. Tuning the inspection method to the desired outcome and conditions is required. This allows the electrical conductivity of the conductive GCL to also be tailored to the desired application and inspection methods. In some cases, the electrical conductivity of the conductive GCL can be quite low, such as where the inspection voltage is high, the defect size is large and the circuit path is short.

Geotextiles are permeable fabrics which, when used in association with soil, have the ability to separate, filter, reinforce, protect, or drain. Typically made from synthetic fibres, such as polypropylene or polyester but potentially including other synthetic fibres, such as: polyamide; acrylonitrile; polylactide; polyester; cellulose; polyurethane; polyethylene and/or semi-synthetic fibres, such as: regenerated cellulose and/or natural fibres, which are primarily cellulosic, such as: abaca; coir; cotton; flax; jute; kapok; kenaf; raffia; bamboo; hemp; modal; piha; ramie; sisal, or; soy protein. Natural fibres are often biodegradable while synthetic fibres are not. Thus, fibre selection depends on the application.

Geotextile fabrics, like other fabrics, can be formed from fibres by many methods, including: weaving, knitting, knotting, braiding and non-woven overlay techniques where further steps, such as inter-tangling (e.g. needle punch, felting, hydro-entanglement, spun-lacing, water needling) and can include various steps to improve the desired properties, such as carding and heat bonding.

Geotextiles, in the context of the present invention, are advantageously made from fibres and are typically either woven or non-woven. Non-woven geotextiles are usually either continuous fibre, also known as filaments, or staple fibre. Staple fibres are shorter lengths that can be formed into a textile. In some cases, the staple fibres are unique fibres and in other clusters of fibres.

Geosynthetics are so named for their use in civil engineering applications including: airfields; bank protection; canals; coastal engineering; dams; debris control; embankments; erosion; railroads; retaining structures, reservoirs; roads; sand dune protection; slope stabilisation; storm surge; stream channels; swales and; wave action.

Various forms of graphene exist. Ideal graphene is pure carbon and is the best electrical conductor in the graphene family. It tends to be free of defects and other chemical substituents, such as oxygen. Graphene oxide (GO) is a highly-oxidised form of graphene that is an electrical insulator. Intermediary species can be referred to by various descriptions, such as partially reduced graphene oxide (prGO) or functionalised graphene, where various chemical groups are attached to the edges and/or basal planes of the graphene.

This functionality allows tailoring of the electrical and physical properties of the graphene, for example to make it easier to incorporate into or onto materials, such as plastics, in order to form composites. Incorporation of ‘heteroatoms’, wherein carbon atoms are replaced by other atoms, such as nitrogen, and other covalently bonded atoms can also be used to tailor the properties of graphene.

Graphene can also come in various dimensions, whether it be single layers of graphene or multiple layers. Various terminologies have been used to describe the structural permutations and some attempts have been made at standardising terminology. Regardless of terminology, these single-layer and multi-layer structures of graphene have useful conductivity that give rise to the properties of composite polymers, fibres and textiles as described herein. These various permutations of graphene are generalised herein as “graphene” unless otherwise detailed and their properties described.

The forms of graphene that can facilitate a scale from electrically conductive to electrically insulating means many forms of graphene can be used as an electrical conductor. Even relatively poorly conducting graphene can serve the purpose, especially where it's other properties make it desirable for use.

Graphene can be produced by many methods, including: anodic bonding; carbon nanotube cleavage; chemical exfoliation; chemical synthesis; chemical vapour deposition; electrochemical exfoliation; electrochemical intercalation; growth on silicon carbide; liquid phase exfoliation; micromechanical cleavage; microwave exfoliation; molecular beam epitaxy; photo-exfoliation; precipitation from metal, and; thermal exfoliation.

Some of these routes give rise to materials referred to as: chemically converted graphene; few-layer graphene; GO; graphene; graphene oxide; graphene nanoflakes; graphene nanoplatelets; graphene nanoribbons; graphene nanosheets; graphite nanoflakes; graphite nanoplatelets; graphite nanosheets; graphite oxide; LCGO; liquid crystal graphene oxide; multi-layer graphene; partially reduced graphene oxide; partially reduced graphite oxide; prGO; rGO; reduced graphene oxide; reduced graphite oxide.

Incorporation of graphene into a textile can be achieved by many methods, but in each case the properties of the fibre and textile will depend on the fibre chemistry, graphene chemistry, graphene shape and processes used to incorporate the graphene into or onto the fibres and the process of forming a textile.

Preferred methods include mixing the graphene into the polymer prior to forming the fibre. However, it is also possible to coat fibres or a textile with graphene to make the conductive textile. The graphene can be present as a powder or as a dispersion in a fluid to facilitate dispersion of the graphene in the polymer. Coating the graphene is preferably from a dispersion of graphene in a fluid.

Methods of incorporation of graphene into the polymer can include: Melt-compounding of graphene into the polymer; in-situ polymerisation of the polymer with the graphene, and; solution blending. Whichever technique is used, it is desirable that the graphene is sufficiently dispersed to achieve electrical conductivity with a minimum of graphene. In some cases, additives are required to reduce phase separation of the graphene and the polymer.

Other conductive additives can be added to the graphene coating or to the graphene-containing polymer. These conductive additives can improve the effectiveness of the graphene in providing electrical conductivity. For example, carbon blacks, carbon fibres and carbon nanotubes are all conductive carbons that can assist with the dispersion of the graphene in the coating liquid or in the polymer mixture and provide further interconnectivity.

A preferred embodiment exists where the conductive geotextile is formed from a fibre that includes graphene, wherein the fibre is formed by melt extrusion from pellets or powders of the polymer. The graphene is added to the melt extrusion in a concentrated form dispersed in a carrier polymer, which may be the same as the bulk polymer, or may be different. The concentrated form of the graphene polymer dispersion is mixed and diluted in the melt extrusion process to obtain the desired concentration of graphene in the fibres.

In an alternative embodiment, the concentrated form of the graphene is dispersed in a fluid, such as: oil, solvent or water.

In another embodiment, the fibres are made by wet-spinning solutions of polymer containing graphene or wet-spinning polymer fibres into coagulation baths containing graphene to produce a surface coating of graphene on the fibre.

In another embodiment, the GCL can be made electrically conductive by the addition of graphene to the clay before incorporation into the GCL.

In another embodiment, the GCL can be made electrically conductive by making the strengthening textile or net electrically conductive by addition of graphene either in the polymer or coated onto the formed textile or net.

### EXAMPLE 1

Approximately 100 cm² rectangles of GCL were made by needle punching conductive geotextile through powdered bentonite clay into a backing of woven non-conductive geonet. The punched geotextile fibres were sealed to the backing geonet by flame melting the protruding fibres. The conductive geotextile was made by coating a non-woven, low weight (150 grams per square meter) PET geotextile with a solution containing a dispersion of graphene to attain 2 weight percent loading of graphene on the geotextile. The electrical resistance of the conductive geotextile was measured to be 2000 Ohms/sq and this was maintained in the assembled GCL.

### EXAMPLE 2

The sample from Example 1 was placed beneath a waterproof geomembrane with a deliberately created hole punched through it. The hole was approximately one millimetre in diameter. When inspected with a spark detector at circa 15,000 volts, the sample of GCL from Example 1 proved a suitable electrical conductor to allow spark testing of the waterproof geomembrane and the hole was reliably detected.

### EXAMPLE 3

100 cm² squares of commercial GCL were used as received and conductive geotextile was adhered to the surface of the existing non-woven, non-conducting geotextile surface by needle punching through the existing GCL. The electrically conductive geotextile was the same material as used in Example 1. Testing of the samples as per Example 2, gave the same result as found in Example 2.

### EXAMPLE 4

100 cm² squares of commercial GCL were used as received and conductive geotextile was adhered to the surface of the existing non-woven, non-conducting geotextile surface by gluing. The electrically conductive geotextile was the same material as used in Example 1. Testing of the samples as per Example 2, gave the same result as found in Example 2.

### EXAMPLE 5

Similarly to Example 1, a GCL was assembled from conductive geotextile where the geotextile was made from staple fibre and had been coated with graphene to be made conductive prior to assembly into the GCL.

### EXAMPLE 6

100 cm² squares of commercial GCL were used as received and the non-conductive geotextile on the surface of the GCL was made conductive by coating with a solution of graphene. Testing of the samples as per Example 2, gave the same result as found in Example 2.

It will be appreciated by those skilled in the art that the above described embodiments are merely several examples of how the inventive concept can be implemented. It will be understood that other embodiments may be conceived that, while differing in their detail, nevertheless fall within the same inventive concept and represent the same invention.

1. A geosynthetic clay liner (GCL) incorporating an electrically conductive textile.

2. The GCL of claim 1, wherein said electrically conductive textile incorporates fibres coated with graphene.

3. The GCL of claim 1, wherein said electrically conductive textile is coated with graphene.

4. The GCL of claim 1, wherein said electrically conductive textile is made from fibres containing graphene.

5. The GCL of claim 1, wherein the electrical conductivity of a circuit formed therefrom may be measured over a distance of at least 1 metre.

6. The GCL of claim 5, wherein the distance is at least 10 metres.

7. The GCL of claim 5, where in the distance is at least 100 metres.

8. The GCL of claim 1, wherein the graphene content of the textile is less than or equal to 20% by mass.

9. The GCL of claim 8, wherein the graphene content of the textile is less than or equal to 10% by mass.

10. The GCL of claim 8, wherein the graphene content of the textile is less than or equal to 5% by mass.

11. The GCL of claim 8, wherein the graphene content of the textile is less than or equal to 2% by mass.

12. The GCL of claim 1, wherein the fibres of the textile are polymer fibres.

13. The GCL of claim 12, wherein said textile polymer is PET, PP or PE.

14. A multi-layer construction incorporating the GCL of claim 1.

15. The multi-layer construction of claim 14, further incorporating a water barrier layer.

16. The multi-layer construction of claim 15, wherein said water barrier layer is an electrical insulator.

17. A multi-layer construction, according to claim 14, for use as part of an inspection process to determine whether the water barrier is intact.

18. A method of inspecting the integrity of a water barrier, wherein said water barrier incorporates a multi-layer sheet according to claim 14, said method including the steps of:
applying a voltage to one side of the sheet proximal to said electrically conductive textile component of the GCL;
detecting whether an electrical circuit is thereby formed in the GCL.

19. The method of claim 18, wherein the resistance of said textile is less than 2500 Ohms per square.

20. The method of claim 18, wherein the resistance of said textile is less than 1000 Ohms per square.

21. The method of claim 18, wherein the resistance of said textile is less than 500 Ohms per square.

22. The method of claim 18, wherein the resistance of said textile is less than 50 Ohms per square.

23. The method of claim 18, wherein the measurement method employs a discontinuous electrical circuit via a capacitance and the resistance of the textile is less than 500,000 Ohms per square.

24. The method of claim 18, wherein the measurement method employs a discontinuous electrical circuit via a capacitance and the resistance of the textile is less than 200,000 Ohms per square.

25. The method of claim 18, wherein the measurement method employs a discontinuous electrical circuit via a capacitance and the resistance of the textile is less than 100,000 Ohms per square.

26. The method of claim 18, wherein the measurement method employs a discontinuous electrical circuit via a capacitance and the resistance of the textile is less than 50,000 Ohms per square.

27. An electrically conductive geosynthetic clay liner (GCL) incorporating a geotextile that contains graphene.
